(19) United States
(12) Patent Application Publication
(10) Pub. No.: US 2015/0207158 A1
(43) Pub. Date: Jul. 23, 2015

(54) FUEL CELL SYSTEM AND ITS OPERATING METHOD

(71) Applicant: TOYOTA JIDOSHA KABUSHIKI KAISHA, Toyota-shi, Aichi-ken (JP)

(72) Inventors: Ryouichi Nanba, Susono-shi (JP); Shigeki Hasegawa, Susono-shi (JP)

(21) Appl. No.: 14/415,812

(22) PCT Filed: Jul. 1, 2013
(86) PCT No.: PCT/JP2013/004072

§ 371 Date: Jan. 20, 2015

(30) Foreign Application Priority Data
Jul. 23, 2012 (JP) PCT/JP2012/004666

(51) Int. Cl. H01M 8/04; H01M 4/92

(52) U.S. Cl. CPC H01M 8/04104; H01M 8/04701; H01M 8/04067; H01M 8/04783; H01M 4/92

(57) ABSTRACT

An object is to suppress the dryness at an anode inlet of a fuel cell stack in a case of power generation at a current density of not lower than 1.4 A/cm² in the fuel cell stack in which a mass of a platinum catalyst per 1 cm² included in a cathode electrode is not higher than 0.2 mg. This object is achievable by performing at least one of controls of controlling temperature of the fuel cell stack to be not lower than 30° C. and not higher than 65° C., controlling a stoichiometric ratio of a cathode gas to be not lower than 1.0 and not higher than 1.5, controlling an outlet pressure of an anode gas to be not lower than 100 kPa and not higher than 250 kPa and controlling a stoichiometric ratio of the anode gas to be not lower than 1.25 and not higher than 5.

### TECHNICAL FIELD

The present invention relates to a fuel cell.

### BACKGROUND ART

There has been a known problem that a cathode inlet in a fuel cell is dried. The cathode inlet denotes an inlet through which a cathode gas such as the air is flowed into each of unit cells constituting a fuel cell stack. The prior art suppresses the dryness at the cathode inlet by increasing the flow rate of a fuel gas or by decreasing the pressure of the fuel gas (for example, Patent Literature 1).

### CITATION LIST

### Patent Literature

[PTL 1] JP 2009-259758A

### SUMMARY

### Technical Problem

The inventors of the present application have predicted a potential problem that a future technical problem is likely to cause the dryness at an anode inlet. The anode inlet denotes an inlet through which an anode gas containing, for example, hydrogen is flowed into each of the unit cells constituting the fuel cell stack. This technical development may increase the current density (for example, 1.4 to 2.5 A/cm²) due to downsizing of the fuel cell stack and may cause the state that the quantity of platinum per unit area of an electrode is further reduced on the cathode side (for example, 0.2 mg/cm² or lower).

For example, in the case of using a carbon nanotube, reducing the quantity of platinum on the cathode side increases the gas diffusion resistance. In the state of increased gas diffusion resistance, increasing the current density is likely to increase the local current density at an in-plane position of a cathode having a high oxygen partial pressure, i.e., in the periphery of a cathode inlet, while being unlikely to increase the local current density at an in-plane position of the cathode having a low oxygen partial pressure, i.e., in the periphery of a cathode outlet. The produced amount of water is accordingly decreased at the in-plane position where the local current density is unlikely to increase. This causes the periphery of the cathode outlet to be readily dried. This results in reducing the amount of water supplied from the periphery of the cathode outlet to the periphery of the anode inlet in the configuration that the flow direction of the cathode gas is opposed to the flow direction of the anode gas. When the amount of water supplied to the periphery of the anode inlet is smaller than the amount of water taken out from the periphery of the anode inlet (amount of evaporation), the anode inlet is dried. Drying the anode inlet deteriorates the overall power generation performance of the fuel cell. An object to be solved by the invention is taken into account this situation.

The fuel cell system may be equipped with a humidification module. The humidification module includes that configured to humidify the cathode gas and that configured to humidify the anode gas. In a configuration of the fuel cell system without a humidification module for humidifying the cathode gas, the cathode gas is used in the state of non-humidified gas. In a configuration of the fuel cell system without a humidification module for humidifying the anode gas, the anode gas is used in the state of non-humidified gas. Compared with a configuration of humidifying both the cathode gas and the anode gas, the dryness at the anode inlet is accelerated in the configuration of using the cathode gas in the state of non-humidified gas while humidifying the anode gas and is further accelerated in the configuration of using both the cathode gas and the anode gas in the state of non-humidified gas. The above problem is made more significant in such cases.

### Solution to Problem

In order to solve the problems described above, the invention may be implemented by any of the following aspects.

(1) According to one aspect, there is provided a fuel cell system, in which a mass of a platinum catalyst per 1 cm² included in a cathode electrode is not higher than 0.2 mg. This fuel cell system includes a fuel cell stack and a dryness reduction processor. The fuel cell stack is configured to receive supplies of an anode gas and a cathode gas such that direction of a flow of the anode gas supplied to an anode is opposed to direction of a flow of the cathode gas supplied to a cathode. The dryness reduction processor is configured to perform at least one of controls of controlling temperature of the fuel cell stack to be not lower than 30° C. and not higher than 65° C., controlling a stoichiometric ratio of the cathode gas to be not lower than 1.0 and not higher than 1.5, controlling an outlet pressure of the anode gas to be not lower than 100 kPa and not higher than 250 kPa and controlling a stoichiometric ratio of the anode gas to be not lower than 1.25 and not higher than 5, in a case of power generation at a current density of not lower than 1.4 A/cm².

Even when the mass of the platinum catalyst per 1 cm² included in the cathode electrode is not higher than 0.2 mg, this fuel cell system suppresses the dryness at an anode inlet in the case of power generation at the current density of not lower than 1.4 A/cm². The temperature of the fuel cell stack in the range of not lower than 30° C. and not higher than 65° C. is often a value of not higher than the temperature of the fuel cell stack under an ordinary condition in the case of power generation at the current density of not lower than 1.4 A/cm². In other words, the dryness reduction processor decreases the temperature of the fuel cell stack to be lower than the temperature of the fuel cell stack under the ordinary condition. Decreasing the temperature of the fuel cell stack suppresses the dryness at the anode inlet. The stoichiometric ratio of the cathode gas in the range of not lower than 1.0 and not higher than 1.5 is often a value of not higher than the stoichiometric ratio of the cathode gas under the ordinary condition in the case of power generation at the current density of not lower than 1.4 A/cm². In other words the dryness reduction processor decreases the stoichiometric ratio of the cathode gas to be lower than the stoichiometric ratio of the cathode gas under the ordinary condition. Decreasing the stoichiometric ratio of the cathode gas reduces the amount of water vapor (amount of evaporation) taken out of the fuel cell stack by the cathode gas. This results in humidifying especially a cathode outlet. Since the flow of the cathode gas is opposed to the flow of the anode gas, humidifying the cathode outlet results in humidifying the anode inlet. This suppresses the dryness at the anode inlet. The stoichiometric ratio herein denotes a ratio calculated by dividing an amount of a reactive gas supplied to a fuel cell by a required amount of the reactive gas for the fuel cell based on a required amount of power generation. The outlet pressure of the anode gas in the range of not lower than 100 kPa and not higher than 250 kPa is often a value of not lower than the outlet pressure of the anode gas under the ordinary condition. In other words, the dryness reduction processor increases the outlet pressure of the anode gas to be higher than the outlet pressure of the anode gas under the ordinary condition. Increasing the outlet pressure of the anode gas decreases the flow rate of the anode gas. Decreasing the flow rate of the anode gas reduces the amount of water taken out from the anode inlet by the anode gas. This results in suppressing the dryness at the anode inlet. The stoichiometric ratio of the anode gas in the range of not lower than 1.0 and not higher than 1.5 is often a value of not higher than the stoichiometric ratio of the anode gas under the ordinary condition. In other words, the dryness reduction processor decreases the stoichiometric ratio of the anode gas to be lower than the stoichiometric ratio of the anode gas under the ordinary condition. Decreasing the stoichiometric ratio of the anode gas decreases the flow rate of the anode gas and accordingly reduces the amount of water taken out from the anode inlet by the anode gas. This results in suppressing the dryness at the anode inlet. Herein “in the case of power generation at the current density of not lower than 1.4 A/cm²” includes during actual power generation at the current density of not lower than 1.4 A/cm² and in the case of prediction of a shift to power generation at the current density of not lower than 1.4 A/cm². In the description hereof, the pressure means an absolute pressure.

(2) In the fuel cell system of the above aspect, the dryness reduction processor may control the temperature of the fuel cell stack to be not lower than 30° C. and not higher than 65° C. and control the stoichiometric ratio of the cathode gas to be not lower than 1.0 and not higher than 1.5. This fuel cell system suppresses the dryness at the anode inlet as described above.

(3) In the fuel cell system of the above aspect, the dryness reduction processor may control the temperature of the fuel cell stack to be not lower than 30° C. and not higher than 50° C. This fuel cell system more effectively suppresses the dryness at the anode inlet.

(4) In the fuel cell system of the above aspect, the dryness reduction processor may control the temperature of the fuel cell stack to be not lower than 30° C. and not higher than 40° C. This fuel cell system more effectively suppresses the dryness at the anode inlet.

(5) In the fuel cell system of the above aspect, the dryness reduction processor may control the stoichiometric ratio of the cathode gas to be not lower than 1.0 and not higher than 1.3. This fuel cell system more effectively suppresses the dryness at the anode inlet.

(6) In the fuel cell system of the above aspect, the dryness reduction processor may control the stoichiometric ratio of the cathode gas to be not lower than 1.0 and not higher than 1.2. This fuel cell system more effectively suppresses the dryness at the anode inlet.

(7) The fuel cell system of the above aspect may further include a target temperature setter configured to set a target temperature of the fuel cell stack to a value under an ordinary operating condition after termination of the control of the temperature by the dryness reduction process. The dryness reduction processor may control the temperature of the fuel cell stack and the stoichiometric ratio of the cathode gas, such that a quotient increases to or above 8.3° C., wherein the quotient is calculated by dividing a difference, which is obtained by subtracting a target temperature set by the dryness reduction processor from the target temperature set by the target temperature setter, by the stoichiometric ratio of the cathode gas controlled to the target value. This fuel cell system more effectively suppresses the dryness at the anode inlet. The effect of decreasing the temperature of the fuel cell stack can be checked by, for example, returning the temperature of the fuel cell stack to the temperature under the ordinary condition (for example, 65° C.).

(8) In the fuel cell system of the above aspect, the dryness reduction processor may control the temperature of the fuel cell stack and the stoichiometric ratio of the cathode gas, such that the quotient increases to or above 10° C. This fuel cell system more effectively suppresses the dryness at the anode inlet.

(9) In the fuel cell system of the above aspect, the dryness reduction processor may terminate the control of the temperature of the fuel cell stack when a cell voltage decreases to or below a reference value. This fuel cell system returns the control to the ordinary condition at an adequate timing.

(10) In the fuel cell system of the above aspect, the dryness reduction processor may terminate the control of the temperature of the fuel cell stack when the temperature of the fuel cell stack decreases to or below a target value. This fuel cell system returns the control to the ordinary condition at an adequate timing.

(11) In the fuel cell system of the above aspect, the dryness reduction processor may terminate the control of the stoichiometric ratio of the cathode gas when a cell voltage decreases to or below a reference value. This fuel cell system returns the control to the ordinary condition at an adequate timing.

(12) In the fuel cell system of the above aspect, the dryness reduction processor may terminate the control of the stoichiometric ratio of the cathode gas when the stoichiometric ratio of the cathode gas decreases to or below a target value. This fuel cell system returns the control to the ordinary condition at an adequate timing.

(13) In the fuel cell system of the above aspect, the dryness reduction processor may control the outlet pressure of the anode gas to be not lower than 100 kPa and not higher than 250 kPa and control the stoichiometric ratio of the anode gas to be not lower than 1.25 and not higher than 5. This fuel cell system suppresses the dryness at the anode inlet as described above.

(14) In the fuel cell system of the above aspect, the dryness reduction processor may control the outlet pressure of the anode gas to be not lower than 150 kPa and not higher than 250 kPa. This fuel cell system more effectively suppresses the dryness at the anode inlet.

(15) In the fuel cell system of the above aspect, the dryness reduction processor may control the outlet pressure of the anode gas to be not lower than 150 kPa and not higher than 200 kPa. This fuel cell system more effectively suppresses the dryness at the anode inlet. The excessively low flow rate of the anode gas causes the anode outlet to be dried. Accordingly, controlling the outlet pressure of the anode gas to the adequate range suppresses the dryness at the anode inlet and at the anode outlet.

(16) In the fuel cell system of the above aspect, the dryness reduction processor may control the stoichiometric ratio of the anode gas to be not lower than 1.25 and not higher than 4. This fuel cell system more effectively suppresses the dryness at the anode inlet.

(17) In the fuel cell system of the above aspect, the dryness reduction processor may control the stoichiometric ratio of the anode gas to be not lower than 1.25 and not higher than 3. This fuel cell system more effectively suppresses the dryness at the anode inlet.

(18) In the fuel cell system of the above aspect, the dryness reduction processor may control the stoichiometric ratio of the anode gas to be not lower than 1.25 and not higher than 2. This fuel cell system more effectively suppresses the dryness at the anode inlet.

(19) In the fuel cell system of the above aspect, the dryness reduction processor may control the stoichiometric ratio of the anode gas to be not lower than 1.25 and not higher than 1.66. This fuel cell system more effectively suppresses the dryness at the anode inlet.

(20) In the fuel cell system of the above aspect, the dryness reduction processor may control the outlet pressure of the anode gas and the stoichiometric ratio of the anode gas, such that a quotient calculated by dividing the outlet pressure of the anode gas by the stoichiometric ratio of the anode gas increases to or above 50 kPa. This fuel cell system more effectively suppresses the dryness at the anode inlet.

(21) In the fuel cell system of the above aspect, the dryness reduction processor may control the outlet pressure of the anode gas and the stoichiometric ratio of the anode gas, such that the quotient increases to or above 83 kPa. This fuel cell system more effectively suppresses the dryness at the anode inlet.

For example, according to one aspect of the invention, this system may include or may not include the dryness reduction processor described above. According to another aspect, for example, the dryness reduction processor may control or may not control the temperature of the fuel cell stack, may control or may not control the stoichiometric ratio of the cathode gas, may control or may not control the outlet pressure of the anode gas, and may control or may not control the stoichiometric ratio of the anode gas. In other words, the dryness reduction processor according to this another aspect may control at least one of the four parameters. According to another aspect, for example, the dryness reduction processor may satisfy or may not satisfy at least one of the controls of controlling the temperature of the fuel cell stack to be not lower than 30° C. and not higher than 50° C. and controlling the stoichiometric ratio of the cathode gas to be not lower than 1.0 and not higher than 1.3. According to another aspect, for example, the dryness reduction processor may satisfy or may not satisfy at least one of the controls of controlling the outlet pressure of the anode gas to be not lower than 150 kPa and not higher than 250 kPa and controlling the stoichiometric ratio of the anode gas to be not lower than 1.25 and not higher than 4.

According to another aspect, the dryness reduction processor may be or may not be based on the technical idea of increasing or decreasing the value to be higher or to be lower than the value under the ordinary condition without any numerical limitation, with regard to at least any one of the above four parameters. This system may be implemented as, for example, a fuel cell system but may be implemented as a different system other than the fuel cell system. This aspect solves at least one of the various problems, such as downsizing of the system, cost reduction, resource saving, ease of manufacture and improvement of usability. Any part or all of the technical features in the respective aspects of the fuel cell system described above may be applied to this system.

The invention may be implemented by any of various aspects other than those described above: for example, an operating method of the fuel cell system, a program for implementing the operating method and a non-transitory storage medium in which the program is stored.

### BRIEF DESCRIPTION OF DRAWINGS

FIG. 1A is a block diagram illustrating the schematic configuration of a fuel cell vehicle;

FIG. 1B is a diagram illustrating a quantity of platinum per unit area;

FIG. 2 is a flowchart showing a dryness reduction process;

FIG. 3 is a flowchart showing an anode stoichiometric ratio control process;

FIG. 4 is a flowchart showing a cathode stoichiometric ratio control process;

FIG. 5 is a flowchart showing a cooling water temperature control process;

FIG. 6 is a flowchart showing an anode pressure control process;

FIG. 7 is tables showing the measured values of a cell voltage and an area resistance when the anode stoichiometric ratio control process and the anode pressure control process were performed;

FIG. 8 is tables showing the measured values of the cell voltage and the area resistance when the cathode stoichiometric ratio control process and the cooling water temperature control process were performed;

FIG. 9 is graphs showing the rates of change of the cell voltage;

FIG. 10 is graphs showing the rates of change of the area resistance;

FIG. 11 is graphs showing the measured values of the cell voltage and the area resistance when the anode stoichiometric ratio control process and the anode pressure control process were performed, with the outlet pressure of the anode gas as abscissa;

FIG. 12 is graphs showing the measured values of the cell voltage and the area resistance when the anode stoichiometric ratio control process and the anode pressure control process were performed, with the stoichiometric ratio of the anode gas as abscissa;

FIG. 13 is graphs showing the measured values of the cell voltage and the area resistance when the cathode stoichiometric ratio control process and the cooling water temperature control process were performed, with the stoichiometric ratio of the cathode gas as abscissa;

FIG. 14 is graphs showing the measured values of the cell voltage and the area resistance when the cathode stoichiometric ratio control process and the cooling water temperature control process were performed, with the cooling water temperature as abscissa;

FIG. 15 is graphs showing the effects by a variation of the value obtained by dividing the outlet pressure of the anode gas by the stoichiometric ratio of the anode gas;

FIG. 16 is graphs showing the effects by a variation of the value obtained by dividing the reduced value of the cooling water temperature by the stoichiometric ratio of the cathode gas;

FIG. 17 is a graph showing relationships between the local current density and the in-plane position and relationships between the local area resistance and the in-plane position; and

FIG. 18 is a graph showing relationships between the cell voltage and the current density and relationships between the area resistance and the current density.

### DESCRIPTION OF EMBODIMENTS

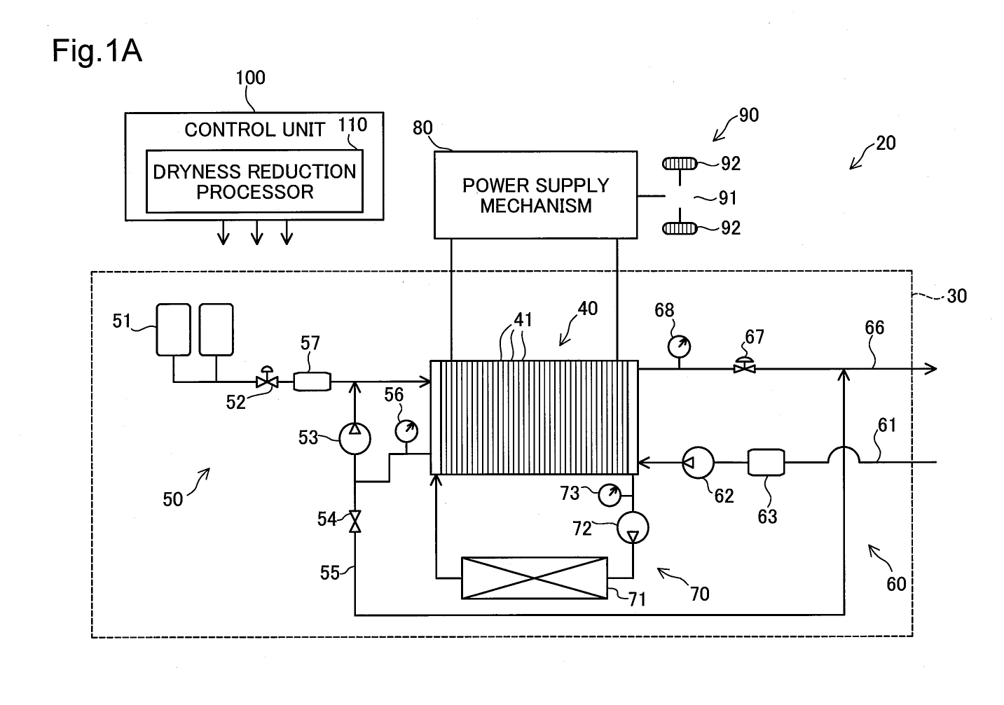

### Hardware Configuration (FIG. 1A):

FIG. 1A is a block diagram illustrating the schematic configuration of a fuel cell vehicle 20. The fuel cell vehicle 20 is a four-wheel vehicle and includes a fuel cell system 30, a power supply mechanism 80, a drive mechanism 90 and a control unit 100 as shown in FIG. 1A.

The fuel cell system 30 employs a solid electrolyte fuel cell and generates electric power through reaction of hydrogen with oxygen. The fuel cell system 30 includes a fuel cell stack 40, an anode gas supply discharge mechanism 50, a cathode gas supply discharge mechanism 60 and a cooling water circulation mechanism 70.

The fuel cell stack 40 is provided by stacking a plurality of unit cells 41. FIG. 1B is a diagram illustrating a membrane electrode assembly 43 of each unit cell 41 viewed from a cathode side. The membrane electrode assembly 43 has the structure that electrode applying regions 47 are formed on both surfaces of an electrolyte membrane 45. The electrode applying region 47 on the cathode side includes a low amount of a platinum catalyst carried on a carbon nanotube. The low amount is, for example, not higher than 0.2 mg/cm² on the electrode applying region 47 on the cathode side. According to another embodiment, the low amount may be any value and may be, for example, not higher than X mg (where X is any value included in the range of 0.01 to 1). As the catalyst, platinum carried on carbon black or a platinum alloy carried on carbon black may be employed, in place of platinum carried on the carbon nanotube described above. The platinum alloy may be an alloy of platinum and at least one metal selected from the group consisting of aluminum, chromium manganese, iron, cobalt, nickel, zirconium, molybdenum, ruthenium, rhodium, palladium, vanadium, tungsten, iridium, titanium and lead.

The anode gas supply discharge mechanism 50 serves to supply an anode gas containing hydrogen to the fuel cell stack 40 and discharge the anode gas from the fuel cell stack 40. The anode gas supply discharge mechanism 50 includes a hydrogen tank 51, a regulator 52, an anode gas circulation pump 53, a purge valve 54, a discharge pathway 55, an anode gas pressure gauge 56 and an injector 57.

The hydrogen tank 51 stores hydrogen. The regulator 52 reduces the pressure of hydrogen stored in the hydrogen tank 51 to a specified pressure and supplies the hydrogen of the reduced pressure to the injector 57. The injector 57 regulates the flow rate and the pressure of the hydrogen supplied from the regulator 52 and supplies the regulated hydrogen as the anode gas to anodes of the respective unit cells 42. The anode gas circulation pump 53 re-supplies the anode gas that is not consumed and is discharged from the anodes to the fuel cell stack 40. The anode gas pressure gauge 56 measures an outlet pressure of the anode gas. The outlet pressure of the anode gas denotes a pressure of the anode gas immediately after discharged from the fuel cell stack 40.

The purge valve 54 is opened as appropriate to discharge the anode gas from the anodes via the discharge pathway 55. The discharge pathway 55 is provided as a passage that connects a circulation path of the anode gas in the anode gas supply discharge mechanism 50 with a cathode gas discharge path 66 (described later) included in the cathode gas supply discharge mechanism 60. The anode gas discharged from the purge valve 54 to the discharge pathway 55 is diluted and is subsequently released through the cathode gas discharge path 66 to the atmosphere.

The anode gas supply discharge mechanism 50 controls the outlet pressure and the stoichiometric ratio of the anode gas to reach separately set target values by means of this configuration. More specifically, the outlet pressure and the stoichiometric ratio of the anode gas are adjusted by controlling the operations of the anode gas circulation pump 53, the purge valve 54 and the injector 57. The stoichiometric ratio is controlled on the assumption that the anode gas has a fixed hydrogen partial pressure. Alternatively an observed value may be used, instead of the assumption of the fixed hydrogen partial pressure.

The cathode gas supply discharge mechanism 60 serves to supply a cathode gas to the fuel cell stack 40 and discharge the cathode gas from the fuel cell stack 40. The flow of the cathode gas and the flow of the anode gas supplied to each of the unit cells 41 are opposed to each other. The cathode gas supply discharge mechanism 60 includes a cathode gas supply path 61, an air compressor 62, an air flow meter 63, the cathode gas discharge path 66, a pressure regulating shutoff valve 67, and a cathode gas pressure gauge 68.

The cathode gas supply path 61 and the cathode gas discharge path 66 are provided as passages that connect the fuel cell stack 40 with open air ports. An air cleaner (not shown) is provided on the open air port of the cathode gas supply path 61. The air compressor 62 is provided in the middle of the cathode gas supply path 61 and is operated to take in the air through the open air port of the cathode gas supply path 61 and compress the intake air. The compressed air is supplied as the cathode gas to the fuel cell stack 40. The air flow meter 63 measures the flow rate of the air taken in by the air compressor 62.

The cathode gas pressure gauge 68 is provided in the middle of the cathode gas discharge path 66 to measure the pressure of the cathode gas immediately after discharged from the fuel cell stack 40. The pressure regulating shutoff valve 67 is provided on the cathode gas discharge path 66 to adjust a flow path cross sectional area of the cathode gas discharge path 66 according to the valve opening position. The cathode gas supply discharge mechanism 60 controls the stoichiometric ratio of the cathode gas to reach a separately set target value by means of this configuration. More specifically, the stoichiometric ratio of the cathode gas is adjusted by controlling the operations of the air compressor 62 and the pressure regulating shutoff valve 67. The stoichiometric ratio is controlled on the assumption that the air has a fixed oxygen partial pressure. Alternatively an observed value may be used, instead of the assumption of the fixed oxygen partial pressure.

The cooling water circulation mechanism 70 serves to cool down the fuel cell stack 40. The cooling water circulation mechanism 70 includes a radiator 71, a cooling water circulation pump 72 and a water temperature gauge 73. The cooling water circulation mechanism 70 circulates cooling water between the fuel cell stack 40 and the radiator 71, so as to control the temperature of the fuel cell stack 40. Such circulation allows for absorption of heat by the fuel cell stack 40 and release of heat by the radiator 71. The water temperature gauge 73 measures the temperature of cooling water immediately after discharged from the radiator 71. The cooling water circulation mechanism 70 controls the temperature of cooling water immediately after discharged from the radiator 71 and thereby controls the temperature of the fuel cell stack 40 by means of this configuration. The temperature of cooling water is adjusted by controlling the circulation amount by the cooling water circulation pump 72 and controlling the operation of a cooling fan of the radiator 71.

The power supply mechanism 80 serves to supply electric power to electrically-driven devices. The electrically-driven devices include, for example, a motor 91 operated to drive drive wheels 92 and the air compressor 62. The power supply mechanism 80 monitors power generation by the fuel cell stack 40. Monitoring power generation includes, for example, measuring the current density, the cell voltage and the area resistance of the cell. The current density, the cell voltage and the area resistance are measured by computation based on the measurement values of electric current and/or voltage of power generated by the entire fuel cell stack 40.

The control unit 100 is provided as an ECU internally having a CPU, a RAM, a ROM and a dryness reduction processor 110. The control unit 100 controls, for example, the fuel cell system 30 and the power supply mechanism 80 described above, in response to a request for power generation.

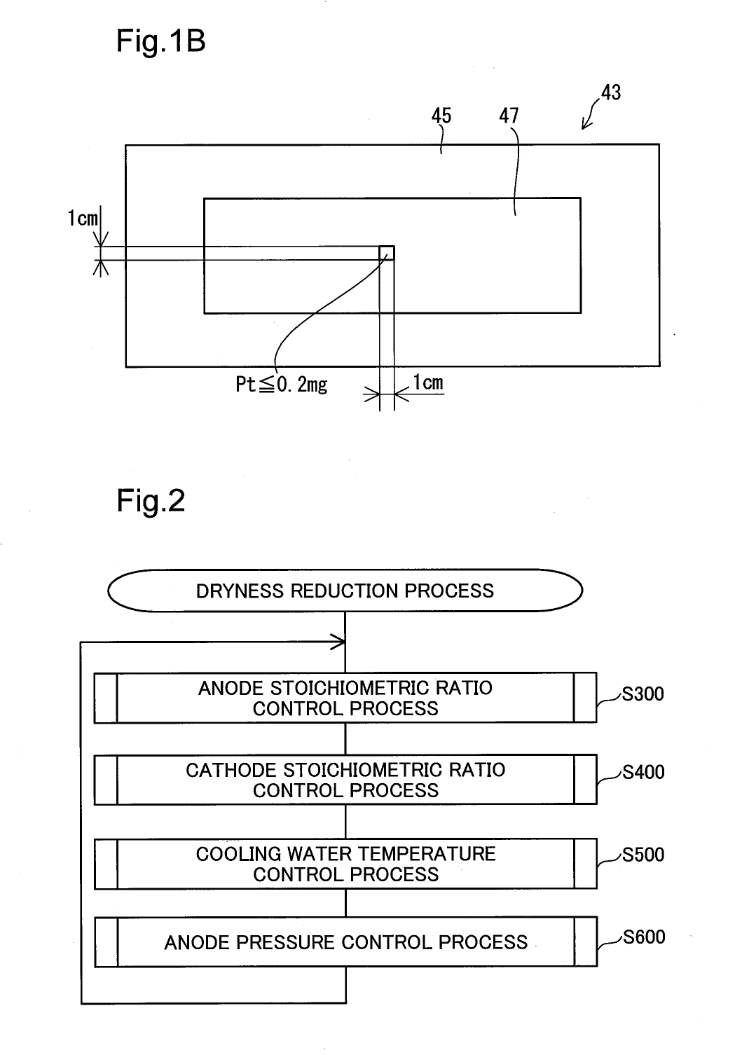

### Dryness Reduction Process (FIG. 2):

FIG. 2 is a flowchart showing a dryness reduction process. The dryness reduction process is mainly performed by the dryness reduction processor included in the control unit 100. The dryness reduction process is triggered by a request for a high load operation for a predetermined time or longer. The high load operation denotes an operation for power generation, for example, at a current density of not lower than 1.4 A/cm². The object of the dryness reduction process is to suppress the dryness in the periphery of an anode inlet in the case of a request for the high load operation and thereby improve the power generation performance.

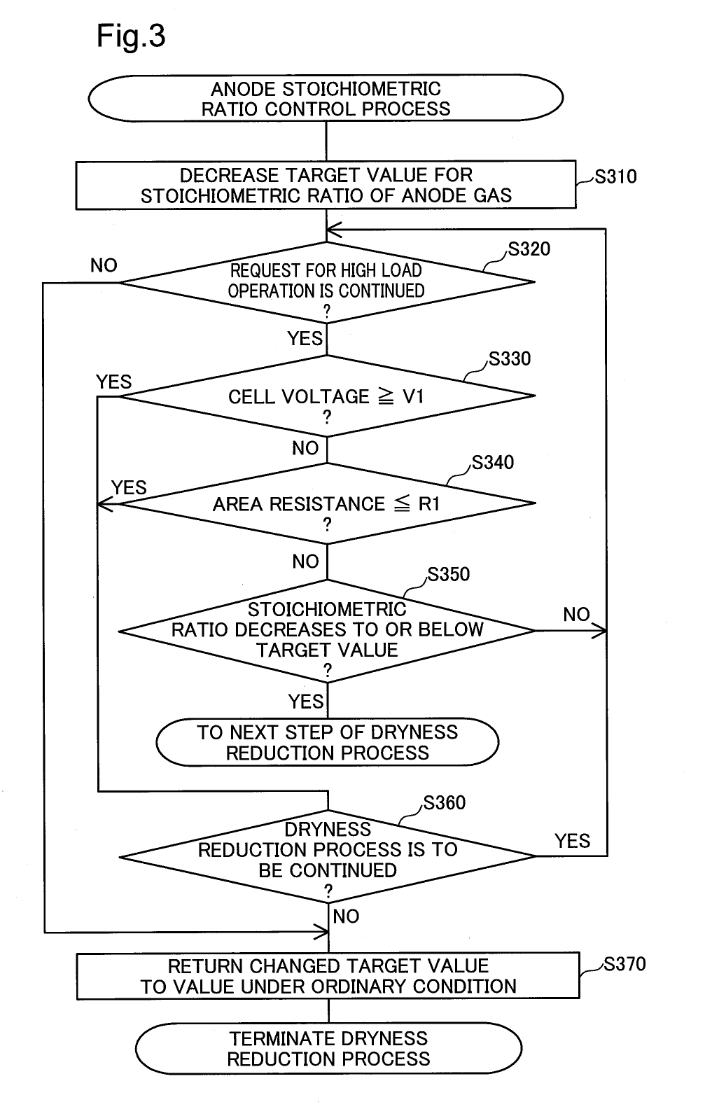

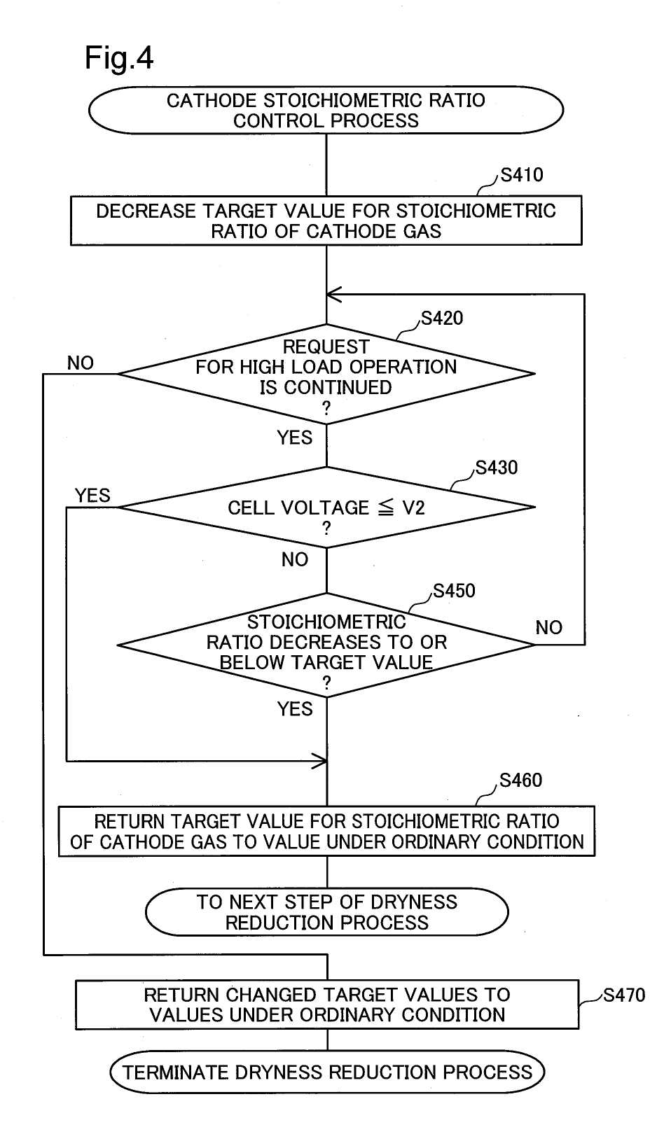

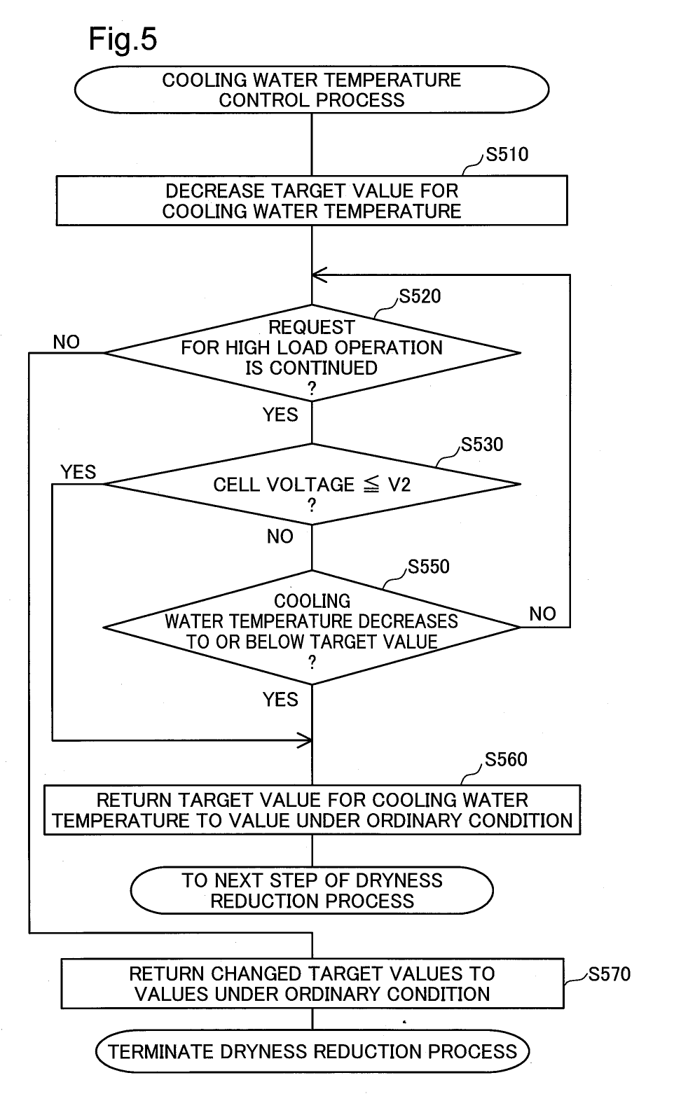

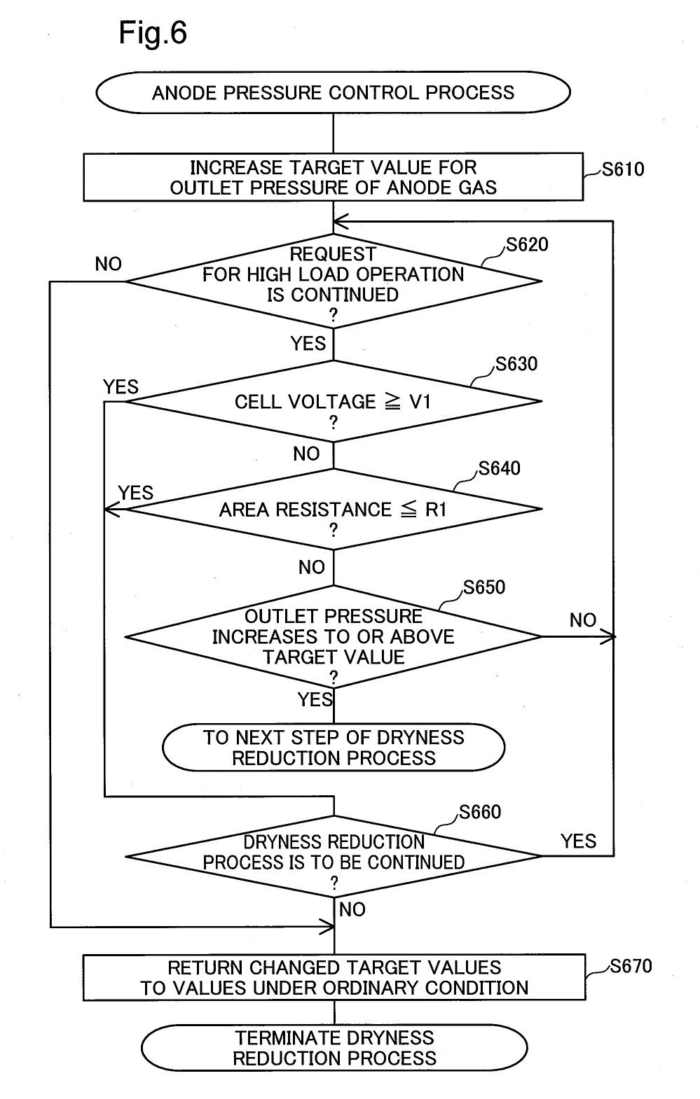

When being started, the dryness reduction process first performs an anode stoichiometric ratio control process (see FIG. 3) (step S300) and subsequently performs a cathode stoichiometric ratio control process (see FIG. 4) (step S400). The dryness reduction process then performs a cooling water temperature control process (see FIG. 5) (step S500), subsequently performs an anode pressure control process (see FIG. 6) (step S600) and returns to the anode stoichiometric ratio control process. In some cases, however, the dryness reduction process may be terminated before the entire processing by the above four subroutines is completed.

### Anode Stoichiometric Ratio Control Process (FIG. 3):

FIG. 3 is a flowchart showing the anode stoichiometric ratio control process. The anode stoichiometric ratio control process first changes a target value for the stoichiometric ratio of the anode gas to be lower than a value under the ordinary condition (step S310). Concrete numerical values will be given later. With a decrease of the target value for the stoichiometric ratio of the anode gas, the stoichiometric ratio of the anode gas is reduced toward the target value by the control of the control unit 100. Such control primarily aims to suppress the dryness at the anode inlet. Suppressing the dryness at the anode inlet is likely to increase the cell voltage and is also likely to decrease the area resistance.

On the premise of the above change by decreasing the target value for the stoichiometric ratio of the anode gas, the anode stoichiometric ratio control process determines whether the request for the high load operation is continued (step S320). When it is determined that the request for the high load operation is continued (step S320: YES), the anode stoichiometric ratio control process subsequently determines whether the cell voltage increases to or above a target voltage V1 (step S330). When it is determined that the cell voltage does not increase to or above the target voltage V1 (step S330: NO), the anode stoichiometric ratio control process subsequently determines whether the area resistance decreases to or below a target resistance R1 (step S340). When it is determined that the area resistance does not decrease to or below the target resistance R1 (step S340: NO), the anode stoichiometric ratio control process returns to step S320.

The request for the high load operation is the premise of performing the dryness reduction process. When the request for the high load operation is not continued (step S320: NO), the anode stoichiometric ratio control process returns the changed target value (more specifically, the target value for the stoichiometric ratio of the anode gas herein) to the ordinary value (step S370), and the dryness reduction process is then terminated. When the request for the high load operation is continued (step S320: YES), on the other hand, the anode stoichiometric ratio control process repeats the above series of determinations (step S330, S340 and S350) with regard to the cell voltage, the area resistance and the stoichiometric ratio of the anode gas.

Suppressing the dryness at the anode inlet increases the cell voltage and decreases the area resistance as described previously. When this results in increasing the cell voltage to or above the target voltage V1 (step S330: YES) or when this results in decreasing the area resistance to or below the target resistance R1 (step S340: YES), the anode stoichiometric ratio control process presumes that the tentative condition for terminating the dryness reduction process is satisfied and subsequently determines whether the dryness reduction process is to be continued (step S360). When it is determined that the dryness reduction process is not to be continued (step S360: NO), the anode stoichiometric ratio control process performs the processing of step S370 described above, and the dryness reduction process is then terminated.

Determination of whether the dryness reduction process is to be continued (step S360) is based on the comprehensive evaluation of the energy balance of the fuel cell vehicle 20. For example, the determination may be performed by taking into account, for example, the fuel consumption and the loads of the respective components. As an example, in the case that an outlet pressure of the anode gas is increased in the anode pressure control process described later, an exemplary procedure may set an upper limit to a time when the outlet pressure is increased and determine that the dryness reduction process is not to be continued when the time reaches the set upper limit. Setting the upper limit to this time aims to restrict the time when the load of the anode gas supply discharge mechanism 50 is increased. Increasing the outlet pressure of the anode gas increases the load of the anode gas supply discharge mechanism 50.

In the course of controlling the stoichiometric ratio of the anode gas by decreasing the target value for the stoichiometric ratio of the anode gas, the stoichiometric ratio of the anode gas may reach the target value (step S350: YES) even when neither the cell voltage nor the area resistance reaches its target value (step S330: NO and step S340: NO). In this case, it is presumed that the dryness at the anode inlet is not sufficiently suppressed by the control of decreasing the stoichiometric ratio of the anode gas. The dryness reduction process then proceeds to a next step with keeping the decreased target value for the stoichiometric ratio of the anode gas.

### Cathode Stoichiometric Ratio Control Process (FIG. 4):

FIG. 4 is a flowchart showing the cathode stoichiometric ratio control process. The cathode stoichiometric ratio control process first changes a target value for the stoichiometric ratio of the cathode gas to be lower than a value under the ordinary condition (step S410). With a decrease of the target value for the stoichiometric ratio of the cathode gas, the stoichiometric ratio of the cathode gas is reduced toward the target value by the control of the control unit 100. Such control aims to suppress the dryness at the anode inlet and to remove an oxide layer formed on a catalyst of the cathode. Decreasing the stoichiometric ratio of the cathode gas, on the other hand, decreases the oxygen partial pressure of the cathode gas especially in the periphery of a cathode outlet. Decreasing the oxygen partial pressure of the cathode gas results in decreasing the cell voltage.

The cathode stoichiometric ratio control process subsequently determines whether the request for the high load operation is continued (step S420). When it is determined that the request for the high load operation is continued (step S420: YES), the cathode stoichiometric ratio control process subsequently determines whether the cell voltage decreases to or below a target value (for example, 0.4 V) (step S430). When it is determined that the cell voltage does not decrease to or below the target value (step S430: NO), the cathode stoichiometric ratio control process subsequently determines whether the stoichiometric ratio of the cathode gas decreases to or below the changed target value (step S450). When it is determined that the stoichiometric ratio of the cathode gas does not decrease to or below the target value (step S450: NO), the cathode stoichiometric ratio control process returns to step S420.

When the request for the high load operation is not continued (step S420: NO), the cathode stoichiometric ratio control process returns the changed target values (more specifically, the target values for the stoichiometric ratio of the cathode gas and the stoichiometric ratio of the anode gas herein) to the ordinary values (step S470), and the dryness reduction process is then terminated. When the request for the high load operation is continued (step S420: YES), on the other hand, the cathode stoichiometric ratio control process repeats the above series of determinations (steps S430 and S450) with regard to the cell voltage and the stoichiometric ratio of the cathode gas.

With a decrease in stoichiometric ratio of the cathode gas, the cell voltage is decreased as described above. When this results in decreasing the cell voltage to or below the target value (step S430: YES), it is presumed that the cathode stoichiometric ratio control process achieves an advantageous effect. The cathode stoichiometric ratio control process then returns the target value for the stoichiometric ratio of the cathode gas to the value under the ordinary condition (step S460), and the dryness reduction process proceeds to a next step. According to this embodiment, the dryness reduction process proceeds to the cooling water temperature control process (step S500). The advantageous effect herein denotes accelerating removal of an oxide layer formed on the surface of a catalyst metal (platinum) especially on the cathode side.

In the course of controlling the stoichiometric ratio of the cathode gas by decreasing the target value for the stoichiometric ratio of the cathode gas, the stoichiometric ratio of the cathode gas may reach the target value (step S450: YES) even when the cell voltage does not reach its target value (step S430: NO). Even in this case, it is presumed that the cathode stoichiometric ratio control process achieves an advantageous effect. The cathode stoichiometric ratio control process then returns the target value for the stoichiometric ratio of the cathode gas to the value under the ordinary condition (step S460), and the dryness reduction process proceeds to a next step. The advantageous effect herein denotes suppressing the dryness especially at the anode inlet.

### Cooling Water Temperature Control Process (FIG. 5):

FIG. 5 is a flowchart showing the cooling water temperature control process. The cooling water temperature control process first changes a target value for the cooling water temperature to be lower than a value under the ordinary condition (step S510) and subsequently determines whether the request for the high load operation is continued (step S520).

When it is determined that the request for the high load operation is continued (step S520: YES), the cooling water temperature control process subsequently determines whether the cell voltage decreases to or below a target voltage V2 (step S530). The target voltage V2 is lower than the target voltage V1 and is, for example, 0.4 V. When it is determined that the cell voltage does not decrease to or below the target voltage V2 (step S530: NO), the cooling water temperature control process subsequently determines whether the cooling water temperature decreases to or below the changed target value (step S550). When it is determined that the cooling water temperature does not decrease to or below the target value (step S550: NO), the cooling water temperature control process returns to step S520.

When it is determined that the request for the high load operation is not continued (step S520: NO), on the other hand, the cooling water temperature control process returns the changed target values to the values under the ordinary condition (step S570), and the dryness reduction process is then terminated. According to this embodiment, the cooling water temperature control process returns the target values for the stoichiometric ratio of the cathode gas and the cooling water temperature to the values under the ordinary condition.

When the cell voltage decreases to or below the target voltage V2 (step S530: YES) or when the cooling water temperature decreases to or below the target value (step S550: YES), on the other hand, the cooling water temperature control process returns the target value for the cooling water temperature to the value under the ordinary condition (step S560), and the dryness reduction process proceeds to a next step. According to this embodiment, the dryness reduction process proceeds to the anode pressure control process (step S600).

The reason why the cooling water temperature is returned to the value under the ordinary condition in response to the affirmative answer YES at step S530 is attributed to the presumption that removal of the oxide layer is accelerated by decreasing the cell voltage. The reason why the target value for the cooling water temperature is returned to the value under the ordinary condition in response to the affirmative answer YES at step S550 is attributed to the presumption that the anode inlet is humidified by decreasing the temperature of the fuel cell stack 40.

### Anode Pressure Control Process (FIG. 6):

FIG. 6 is a flowchart showing the anode pressure control process. The anode pressure control process first changes a target value for the outlet pressure of the anode gas to be higher than a value under the ordinary condition (step S610). With an increase of the target value for the outlet pressure of the anode gas, the outlet pressure of the anode gas is increased by the control of the control unit 100, so as to suppress the dryness at the anode inlet. This results in increasing the cell voltage and decreasing the area resistance.

The anode pressure control process subsequently determines whether the request for the high load operation is continued (step S620). When it is determined that the request for the high load operation is continued (step S620: YES), the anode pressure control process determines whether the cell voltage increases to or above a target voltage V1 (step S630). When it is determined that the cell voltage does not increase to or above the target voltage V1 (step S630: NO), the anode pressure control process subsequently determines whether the area resistance decreases to or below a target resistance R1 (step S640).

When it is determined that the area resistance does not decrease to or below the target resistance R1 (step S640: NO), the anode pressure control process determines whether the outlet pressure of the anode gas increases to or above the changed target value (step S650). When it is determined that the outlet pressure of the anode gas does not increase to or above the target value (step S650: NO), the anode pressure control process returns to step S620.

When it is determined that the request for the high load operation is not continued (step S620: NO), on the other hand, the anode pressure control process returns the changed target values to the values under the ordinary condition (step S670), and the dryness reduction process is then terminated. According to this embodiment, the anode pressure control process returns the target values for the stoichiometric ratio of the anode gas and the outlet pressure of the anode gas to the values under the ordinary condition.

When it is determined that the cell voltage increases to or above the target voltage V1 (step S630: YES) or when it is determined that the area resistance decreases to or below the target resistance R1 (step S640: YES), on the other hand, the anode pressure control process determines whether the dryness reduction process is to be continued (step S660). When it is determined that the dryness reduction process is not to be continued (step S660: NO), the anode pressure control process performs the processing of step S670 described above, and the dryness reduction process is then terminated.

The reason why the dryness reduction process is terminated in response to the affirmative answer YES at step S630 or the affirmative answer YES at step S640 is attributed to the presumption that the inlet of the anode gas is humidified. The reason why the dryness reduction process proceeds to a next step with keeping the increased target value for the outlet pressure of the anode gas in response to the affirmative answer YES at step S650 is attributed to that neither the cell voltage nor the area resistance reaches the target value, while the outlet pressure of the anode gas reaches the target value.

When it is determined that the outlet pressure of the anode gas increases to or above the target value (step S650: YES), on the other hand, the dryness reduction process proceeds to a next step. According to this embodiment, the dryness reduction process performs the anode stoichiometric ratio control process (step S300).

### Other Embodiments

The dryness reduction process described above may be modified in any of various embodiments. For example, the execution sequence of the anode stoichiometric ratio control process, the cathode stoichiometric ratio control process, the cooling water temperature control process and the anode pressure control process may be changed in any of various ways. The execution sequence according to the embodiment described above is the descending order of the responsiveness of the process. Alternatively, for example, the execution sequence may be the descending order of the effectiveness of the process, i.e., the cooling water temperature control process, the cathode stoichiometric ratio control process, the anode pressure control process and the anode stoichiometric ratio control process. Any two or more of the processes may be performed simultaneously, instead of the sequential execution.

There is only a need to perform at least any one of the anode stoichiometric ratio control process, the cathode stoichiometric ratio control process, the cooling water temperature control process and the anode pressure control process.

In the anode stoichiometric ratio control process and/or the anode pressure control process, only either one of the cell voltage and the area resistance may be employed as the trigger for determining whether the dryness reduction process is to be terminated. For example, in the anode stoichiometric ratio control process, either one of step S330 and S340 may be omitted.

In the cathode stoichiometric ratio control process and/or the cooling water temperature control process, the area resistance may be employed in addition to or in place of the cell voltage, as the parameter for determining whether the dryness reduction process is to be terminated. For example, in the cathode stoichiometric ratio control process, the processing of step S430 may be changed to determination of “whether the area resistance increases to or above the target value”. The timing when the dryness reduction process is started may be changed in any of various ways. For example, an abrupt increase of the current density may be employed as the trigger of the dryness reduction process.

The dryness reduction process is especially effective in the case of power generation at the high current density under the conditions that a low quantity of a platinum catalyst is employed on the cathode side, together when omission of a humidification mechanism for the cathode gas or omission of a humidification mechanism for the cathode gas and the anode gas. Even in the case where at least one of these conditions is not satisfied, however, the dryness reduction process is still effective when the periphery of the anode inlet and/or the periphery of the cathode outlet is dried or is expected to be dried.

### EXAMPLES

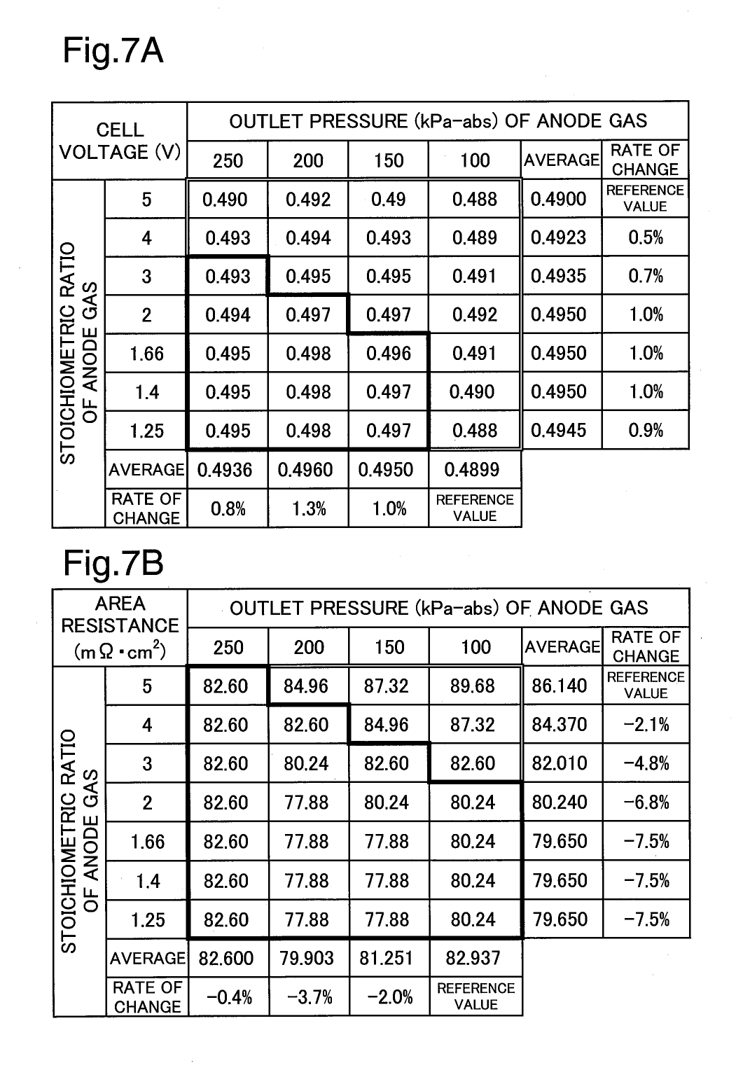

FIG. 7(A) is a table showing the measured values of the cell voltage when the anode stoichiometric ratio control process and the anode pressure control process were performed as the dryness reduction process. FIG. 7(B) is a table showing the measured values of the area resistance when the anode stoichiometric ratio control process and the anode pressure control process were performed as the dryness reduction process. A plurality of values were subject to the measurement with regard to each of the target value for the stoichiometric ratio of the anode gas and the target value for the outlet pressure of the anode gas.

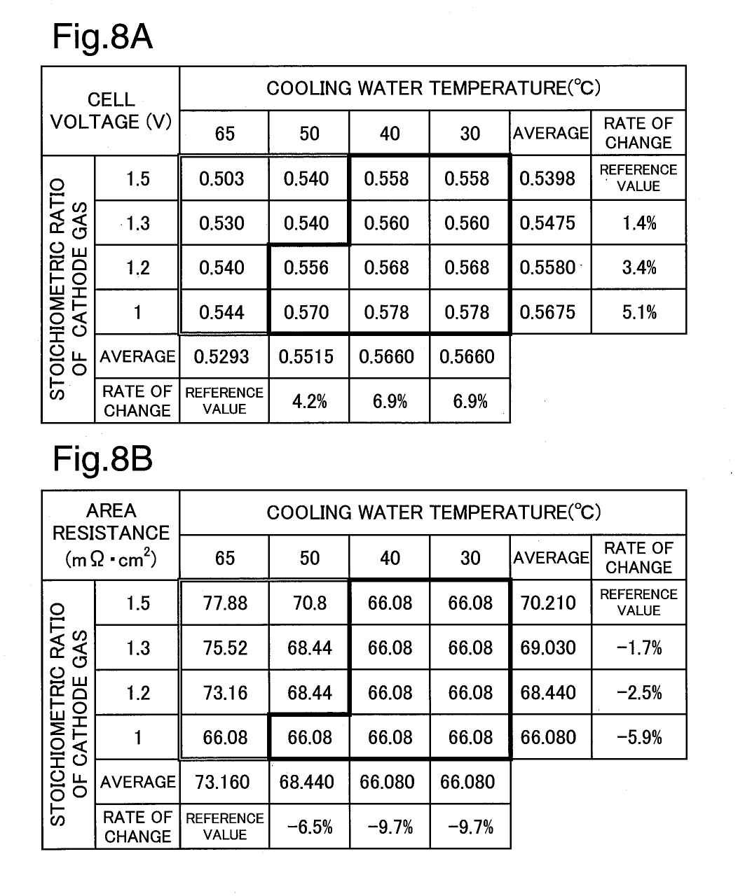

FIG. 8(A) is a table showing the measured values of the cell voltage when the cathode stoichiometric ratio control process and the cooling water temperature control process were performed. FIG. 8(B) is a table showing the measured values of the area resistance when the cathode stoichiometric ratio control process and the cooling water temperature control process were performed. A plurality of values were subject to the measurement with regard to each of the target value for the stoichiometric ratio of the cathode gas and the target value for the cooling water temperature.

The “average” shown in FIGS. 7 and 8 denotes an average of the measured values under a fixed condition of one of the parameters. For example, the average at the stoichiometric ratio of the anode gas equal to 5 denotes an average of the measured values under the condition of the four different outlet pressures of the anode gas, i.e., 100, 150, 200 and 250 kPa at the stoichiometric ratio of the anode gas equal to 5.

The “rate of change” shown in FIGS. 7 and 8 denotes a degree of change of the above average from a corresponding reference value. The reference value of the stoichiometric ratio of the anode gas is 5; the reference value of the outlet pressure of the anode gas is 100 kPa; the reference value of the stoichiometric ratio of the cathode gas is 1.5; and the reference value of the cooling water temperature is 65° C. These reference values may be used as the ordinary conditions. The thick frames shown in FIGS. 7 and 8 indicate desired ranges. Its reason will be described later.

Each of the measured values shown in FIG. 7 may be used as the target voltage V1 in the dryness reduction process. Each of the measured values shown in FIG. 8 may be used as the target resistance R1 in the dryness reduction process. For example, in the case where 200 kPa is employed as the target value for the outlet pressure of the anode gas and 1.25 is employed as the target value for the stoichiometric ratio of the anode gas, 0.498 V may be used as the target voltage V1 and 77.88 mΩ·cm² may be used as the target resistance R1. These values may be replaced by values obtained by increasing or decreasing these values at specified ratios.

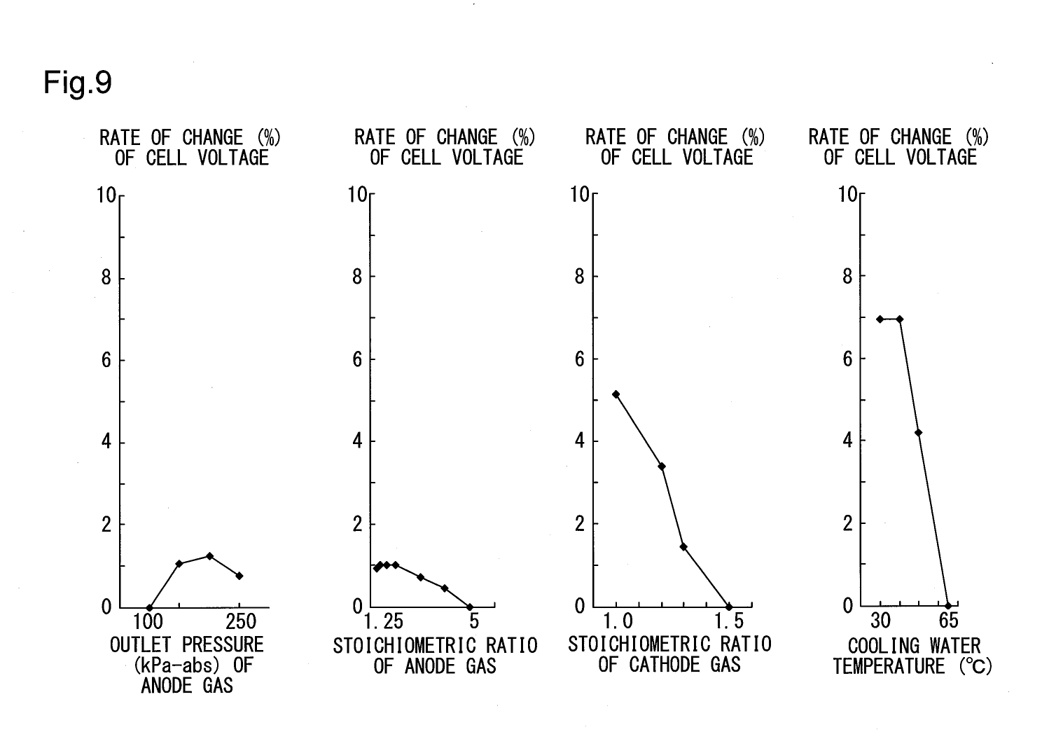

FIG. 9 is graphs showing the rates of change of the cell voltage shown in FIGS. 7(A) and 8(A). As shown in FIG. 9, with regard to any of the parameters, the cell voltages at the values other than the reference value are higher than the cell voltage at the reference value, so that the values other than the reference value are preferable rather than the reference value. As the more preferable numerical range, the outlet pressure of the anode gas is preferably 150 to 200 kPa rather than 250 kPa as shown in FIG. 9. The stoichiometric ratio of the anode gas is preferably 1.25 to 3 rather than 4, is more preferably 1.25 to 2 and is furthermore preferably 1.25 to 1.4 as shown in FIG. 9. The stoichiometric ratio of the cathode gas is preferably 1 to 1.2 rather than 1.3 as shown in FIG. 9. The cooling water temperature is preferably 30 to 40° C. rather than 50° C. as shown in FIG. 9.

As shown in FIG. 9, the effect by the cooling water temperature is most significant, and the effect by the stoichiometric ratio of the cathode gas is second most significant. This reason may be that the cooling water temperature control process and the cathode stoichiometric ratio control process remove the oxide layer on the surface of platinum on the cathode side as described previously, in addition to humidifying the anode inlet. The reason why the oxide layer of the cathode is removed may be attributed to that the cooling water temperature control process and the cathode stoichiometric ratio control process cause a decrease of the cell voltage and thereby a decrease of the cathode potential and humidify the cathode. The water content of the cathode has the effect of removing the impurity adhering to the surface of platinum of the cathode. The impurity may be, for example, sulfonic acid group. The sulfonic acid group may be freed from the electrolyte membrane 45 or from an ionomer. The ionomer may be included in, for example, the electrode applying region 47. In order to further enhance this effect, it is preferable to perform the cathode stoichiometric ratio control process subsequent to the cooling water temperature control process. This sequence is effective for removal of the oxide layer on the surface of platinum of the cathode and the impurity on the surface of platinum.

Unlike the control of the cooling water temperature and the control of the stoichiometric ratio of the cathode gas, the control of the outlet pressure of the anode gas and the control of the stoichiometric ratio of the anode gas are advantageous to quickly achieve the effects without temporarily decreasing the cell voltage. In the case that the anode pressure control process and the anode stoichiometric ratio control process are performed, it is preferable to perform the anode stoichiometric ratio control process subsequent to the anode pressure control process. This is because the higher stoichiometric ratio (higher flow rate) has the better responsiveness of the pressure control.

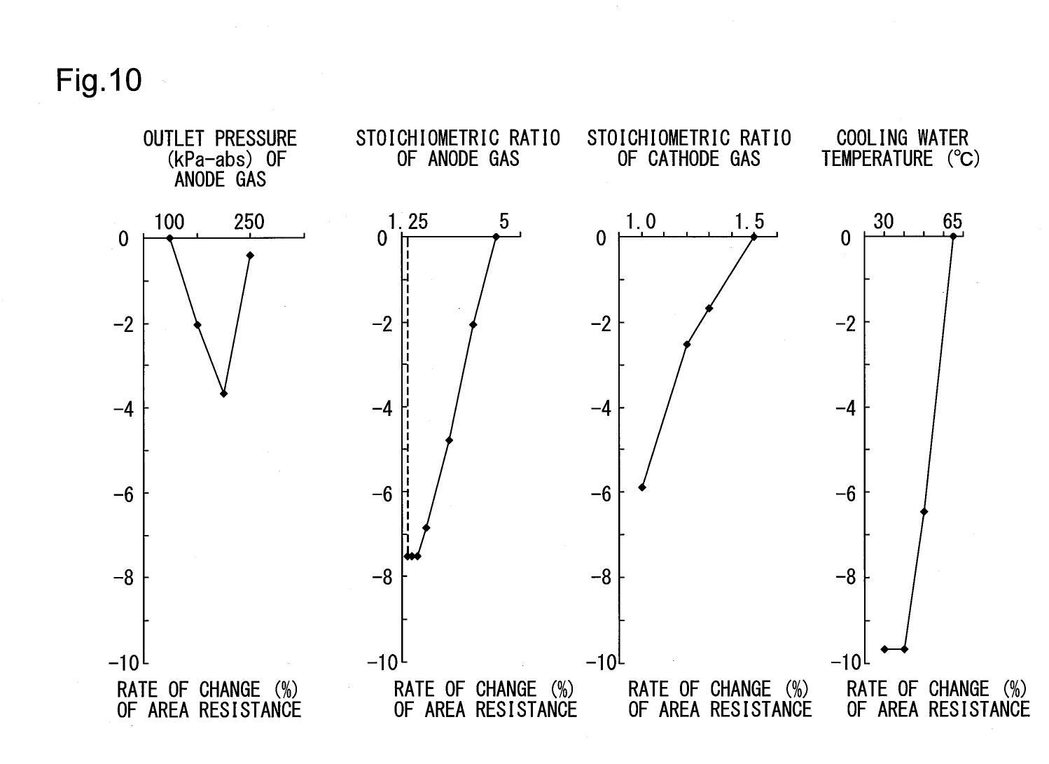

FIG. 10 is graphs showing the rates of change of the area resistance shown in FIGS. 7(B) and 8(B). With regard to any of the parameters, the area resistances at the values other than the reference value are lower than the area resistance at the reference value, so that the values other than the reference value are preferable rather than the reference value. As the more preferable numerical range, the stoichiometric ratio of the anode gas is preferably 1.25 to 3 rather than 4, is more preferably 1.25 to 2 and is furthermore preferably 1.25 to 1.66 as shown in FIG. 10. By additionally taking into account the cell voltage described with reference to FIG. 9, the range of 1.25 to 1.4 is especially more preferable. The preferable ranges with regard to the other parameters are similar to those of the cell voltage. As shown in FIG. 10, the effect by the cooling water temperature is most significant, and the effect by the stoichiometric ratio of the anode gas is second most significant.

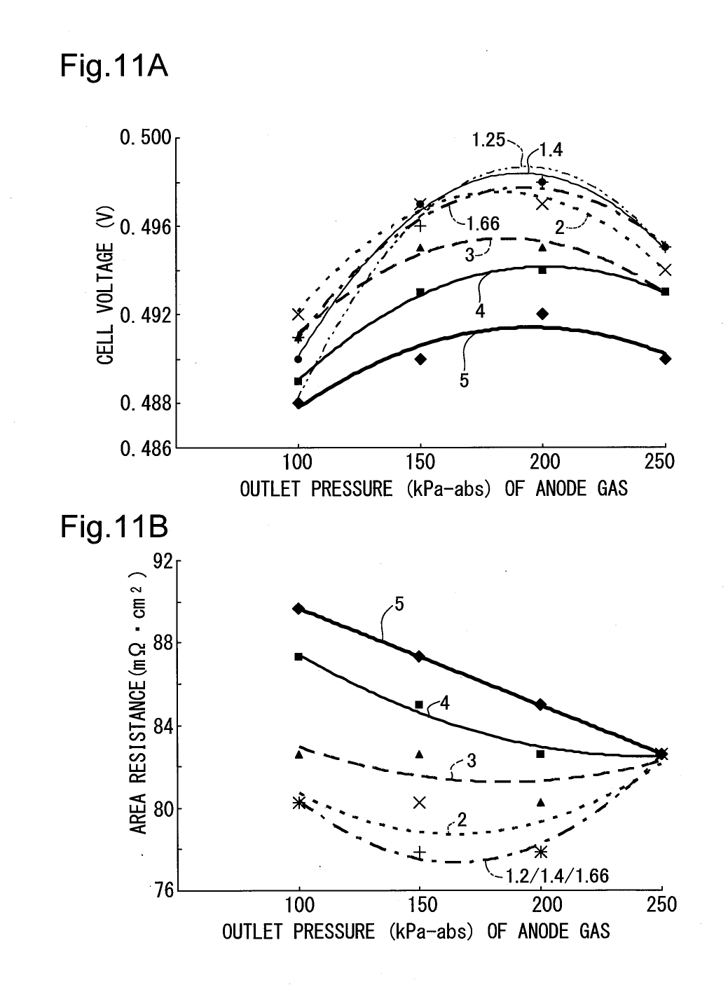

FIG. 11(A) is a graph showing variations in numerical value shown in FIG. 7(A). This graph has the cell voltage as ordinate and the outlet pressure of the anode gas as abscissa. FIG. 11(B) is a graph showing variations in numerical value shown in FIG. 7(B). This graph has the area resistance as ordinate and the outlet pressure of the anode gas as abscissa. The numerical values attached to the respective curves in the graph denote the stoichiometric ratios of the anode gas.

As shown in FIG. 11(A), in the case of any of the stoichiometric ratios of the anode gas, the cell voltages at the outlet pressure of the anode in the range of 150 to 250 kPa are higher than the cell voltage at the outlet pressure of the anode equal to 100 kPa. Accordingly, the outlet pressure of the anode is preferably 150 to 250 kPa.

As shown in FIG. 11(A), in the case of any of the stoichiometric ratios of the anode gas, the cell voltages at the outlet pressure of the anode in the range of 150 to 200 kPa are higher than the cell voltage at the outlet pressure of the anode equal to 250 kPa. Accordingly, the outlet pressure of the anode is preferably 150 to 200 kPa.

As shown in FIG. 11(A), the cell voltage does not monotonically increase with an increase in outlet pressure of the anode gas. FIG. 11(A) shows approximate curves by a quadratic function. The peaks of these quadratic curves fall in the range of 191 to 201 kPa. Accordingly, in this embodiment, the outlet pressure of the anode gas is preferably 191 to 201 kPa.

As shown in FIG. 11(B), when the stoichiometric ratio of the anode gas is equal to 5, the area resistance monotonically decreases with an increase in outlet pressure of the anode gas. Accordingly, when the stoichiometric ratio of the anode gas is equal to 5, the outlet pressure of the anode gas is preferably 150 to 250 kPa and is more preferably 200 to 250 kPa.

As shown in FIG. 11(B), when the stoichiometric ratio of the anode is in the range of 1.2 to 1.66 or is equal to 4, the area resistances at the outlet pressure of the anode gas in the range of 150 to 200 kPa are lower than the area resistance at the outlet pressure of the anode gas equal to 100 kPa. Accordingly, when the stoichiometric ratio of the anode gas is in the range of 1.2 to 1.66 or is equal to 4, the outlet pressure of the anode gas is preferably 150 to 200 kPa.

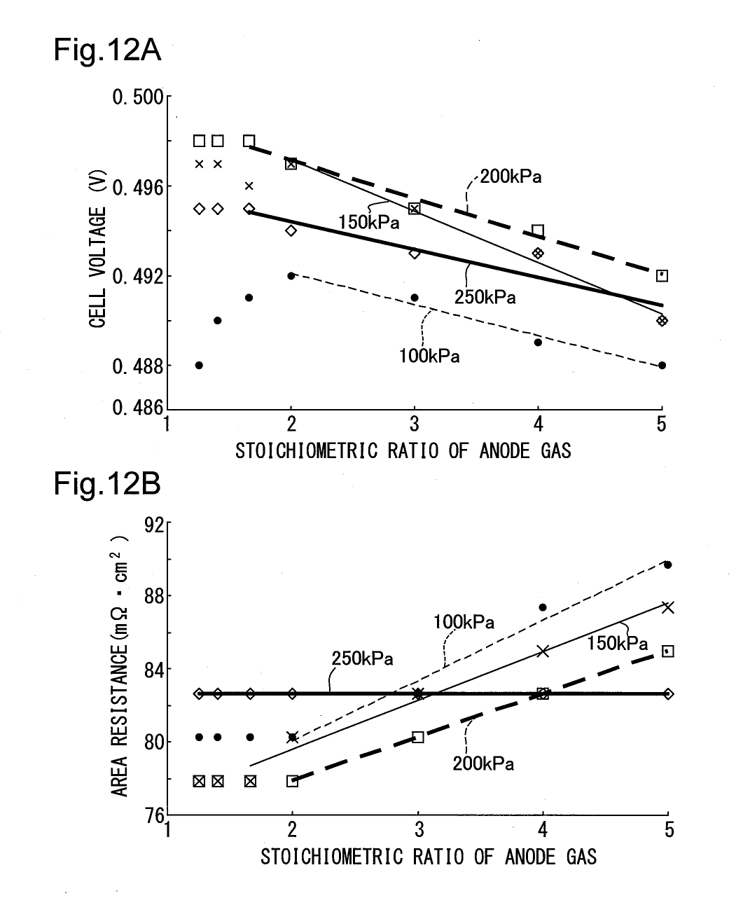

FIG. 12(A) is a graph showing variations in numerical value shown in FIG. 7(A). This graph has the cell voltage as ordinate and the stoichiometric ratio of the anode gas as abscissa. FIG. 12(B) is a graph showing variations in numerical value shown in FIG. 7(B). This graph has the area resistance as ordinate and the stoichiometric ratio of the anode gas as abscissa. The numerical values attached to the respective curves in the graph denote the outlet pressures of the anode gas.

As shown in FIG. 12(A), when the outlet pressure of the anode gas is in the range of 150 to 250 kPa, the cell voltages at the stoichiometric ratio of the anode gas in the range of 1.25 to 4 are higher than the cell voltage at the stoichiometric ratio of the anode gas equal to 5. Accordingly, when the outlet pressure of the anode gas is in the range of 150 to 250 kPa, the stoichiometric ratio of the anode gas is preferably 1.25 to 4.

As shown in FIG. 12(A), when the outlet pressure of the anode gas is in the range of 150 to 200 kPa, the cell voltages at the stoichiometric ratio of the anode gas in the range of 1.25 to 3 are higher than the cell voltages at the stoichiometric ratio of the anode gas in the range of 4 to 5. Accordingly, when the outlet pressure of the anode gas is in the range of 150 to 200 kPa, the stoichiometric ratio of the anode gas is preferably 1.25 to 3.

As shown in FIG. 12(A), when the outlet pressure of the anode gas is in the range of 150 to 250 kPa, the cell voltages at the stoichiometric ratio of the anode gas in the range of 1.25 to 2 are higher than the cell voltages at the stoichiometric ratio of the anode in the range of 3 to 5. Accordingly, when the outlet pressure of the anode gas is in the range of 150 to 250 kPa, the stoichiometric ratio of the anode gas is preferably 1.25 to 2.

As shown in FIG. 12(A), when the outlet pressure of the anode gas is in the range of 200 to 250 kPa, the cell voltages at the stoichiometric ratio of the anode gas in the range of 1.25 to 1.66 are higher than the cell voltages at the stoichiometric ratio of the anode gas in the range of 2 to 5. Accordingly, when the outlet pressure of the anode gas is in the range of 200 to 250 kPa, the stoichiometric ratio of the anode gas is preferably 1.25 to 1.66.

As shown in FIG. 12(B), when the outlet pressure of the anode gas is in the range of 100 to 200 kPa, the area resistances at the stoichiometric ratio of the anode gas in the range of 1.25 to 4 are lower than the area resistance at the stoichiometric ratio of the anode gas equal to 5. Accordingly, when the outlet pressure of the anode gas is in the range of 100 to 200 kPa, the stoichiometric ratio of the anode gas is preferably 1.25 to 4.

As shown in FIG. 12(B), when the outlet pressure of the anode gas is in the range of 100 to 200 kPa, the area resistances at the stoichiometric ratio of the anode gas in the range of 1.25 to 3 are lower than the area resistances at the stoichiometric ratio of the anode gas in the range of 4 to 5. Accordingly, when the outlet pressure of the anode gas is in the range of 100 to 200 kPa, the stoichiometric ratio of the anode gas is preferably 1.25 to 3.

As shown in FIG. 12(B), when the outlet pressure of the anode gas is in the range of 100 to 200 kPa, the area resistances at the stoichiometric ratio of the anode gas in the range of 1.25 to 2 are lower than the area resistances at the stoichiometric ratio of the anode gas in the range of 3 to 5. Accordingly, when the outlet pressure of the anode gas is in the range of 100 to 200 kPa, the stoichiometric ratio of the anode gas is preferably 1.25 to 2.

As shown in FIG. 12(B), when the outlet pressure of the anode gas is equal to 150 kPa, the area resistances at the stoichiometric ratio of the anode gas in the range of 1.25 to 1.66 are lower than the area resistances at the stoichiometric ratio of the anode gas in the range of 2 to 5. Accordingly, when the outlet pressure of the anode gas is equal to 150 kPa, the stoichiometric ratio of the anode gas is preferably 1.25 to

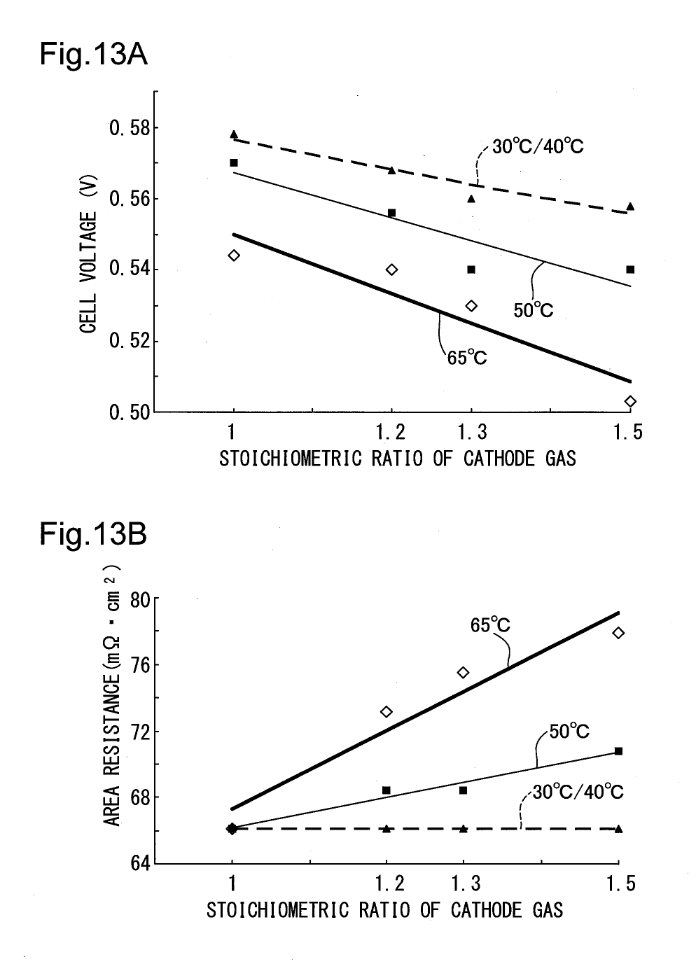

FIG. 13(A) is a graph showing variations in numerical value shown in FIG. 8(A). This graph has the cell voltage as ordinate and the stoichiometric ratio of the cathode gas as abscissa. FIG. 13(B) is a graph showing variations in numerical value shown in FIG. 8(B). This graph has the area resistance as ordinate and the stoichiometric ratio of the cathode gas as abscissa. The numerical values attached to the respective curves in the graph denote the cooling water temperatures.

As shown in FIG. 13(A), when the cooling water temperature is in the range of 30 to 40° C. or is equal to 65° C., the cell voltages at the stoichiometric ratio of the cathode gas in the range of 1.0 to 1.3 are higher than the cell voltage at the stoichiometric ratio of the cathode gas equal to 1.5. Accordingly, when the cooling water temperature is in the range of 30 to 40° C. or is equal to 65° C., the stoichiometric ratio of the cathode gas is preferably 1.0 to 1.3. In the case of any of the cooling water temperatures, the cell voltages at the stoichiometric ratio of the cathode gas in the range of 1.0 to 1.2 are higher than the cell voltage at the stoichiometric ratio of the cathode gas equal to 1.3. Accordingly, the stoichiometric ratio of the cathode gas is preferably 1.0 to 1.2.

As shown in FIG. 13(B), when the cooling water temperature is in the range of 50 to 65° C., the area resistances at the stoichiometric ratio of the cathode gas in the range of 1.0 to 1.3 are lower than the area resistance at the stoichiometric ratio of the cathode gas equal to 1.5. Accordingly, when the cooling water temperature is in the range of 50 to 65° C., the stoichiometric ratio of the cathode gas is preferably 1.0 to 1.3. When the cooling water temperature is equal to 65° C., the area resistances at the stoichiometric ratio of the cathode gas in the range of 1.0 to 1.2 are lower than the area resistance at the stoichiometric ratio of the cathode gas equal to 1.3. Accordingly, when the cooling water temperature is equal to 65° C., the stoichiometric ratio of the cathode gas is preferably 1.0 to 1.2.

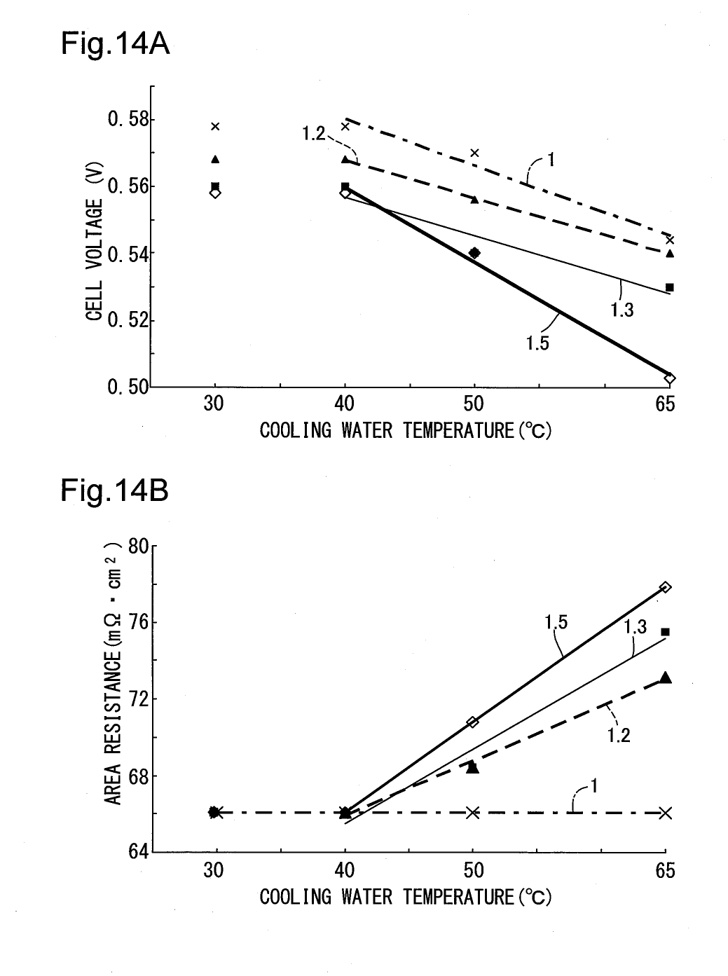

FIG. 14(A) is a graph showing variations in numerical value shown in FIG. 8(A). This graph has the cell voltage as ordinate and the cooling water temperature as abscissa. FIG. 14(B) is a graph showing variations in numerical value shown in FIG. 8(B). This graph has the area resistance as ordinate and the cooling water temperature as abscissa. The numerical values attached to the respective curves in the graph denote the stoichiometric ratios of the cathode gas.

As shown in FIG. 14(A), in the case of any of the cooling water temperatures, the cell voltages at the cooling water temperature in the range of 30 to 50° C. are higher than the cell voltage at the cooling water temperature equal to 65° C. Accordingly, the cooling water temperature is preferably 30 to 50° C. As shown in FIG. 14(A), in the case of any of the cooling water temperatures, the cell voltages at the cooling water temperature in the range of 30 to 40° C. are higher than the cell voltage at the cooling water temperature equal to 50° C. Accordingly, the cooling water temperature is preferably 30 to 40° C.

As shown in FIG. 14(B), when the stoichiometric ratio of the cathode gas is in the range of 1.2 to 1.5, the area resistances at the cooling water temperature in the range of 30 to 50° C. are lower than the area resistance at the cooling water temperature equal to 65° C. Accordingly, when the stoichiometric ratio of the cathode gas is in the range of 1.2 to 1.5, the cooling water temperature is preferably 30 to 50° C. As shown in FIG. 14(B), when the stoichiometric ratio of the cathode gas is in the range of 1.2 to 1.5, the area resistances at the cooling water temperature in the range of 30 to 40° C. are lower than the area resistance at the cooling water temperature equal to 50° C. Accordingly, when the stoichiometric ratio of the cathode gas is in the range of 1.2 to 1.5, the cooling water temperature is preferably 30 to 40° C.

As shown in FIGS. 11 to 14, a variation in one of the parameters causes an increase of the cell voltage and a decrease of the area resistance even when the other parameter is set to the ordinary condition. This means that the effect can be achieved by performing any one of the anode stoichiometric ratio control process, the cathode stoichiometric ratio control process, the cooling water temperature control process and the anode pressure control process.

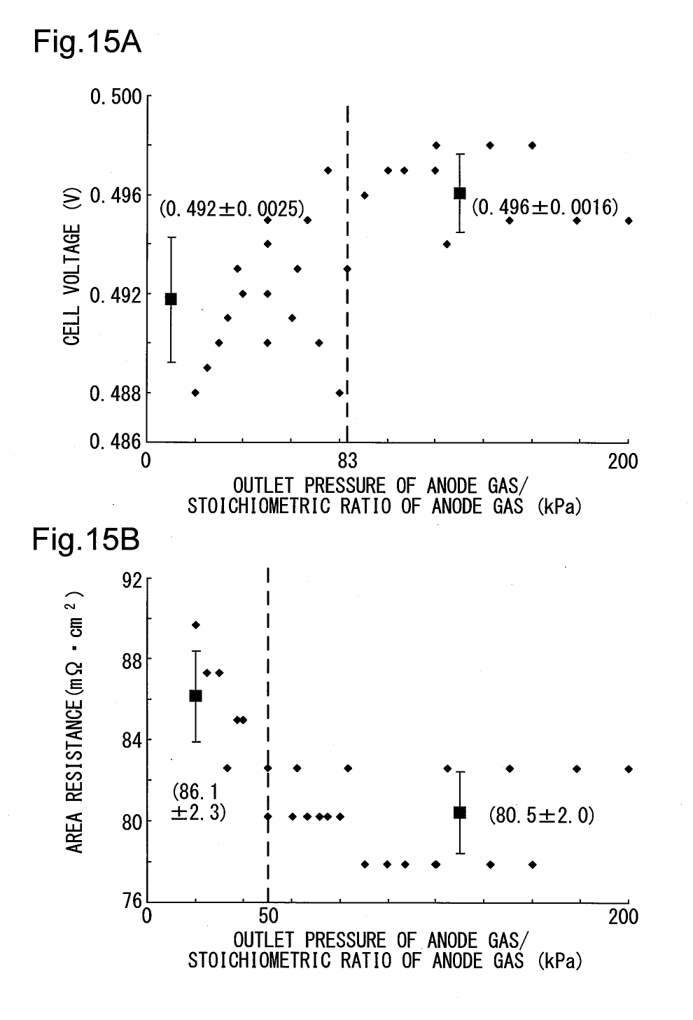

FIG. 15(A) is a graph with the cell voltage as ordinate and with the quotient (hereinafter referred to as “value α”) calculated by dividing the outlet pressure of the anode gas by the stoichiometric ratio of the anode gas as abscissa. FIG. 15(B) is a graph with the area resistance as ordinate and the value α as abscissa.

As shown in FIG. 15(A), the value α of not lower than 83 kPa gives the higher average value of the cell voltage and the less variation of the cell voltage, compared with the value α of lower than 83 kPa. When the value a is not lower than 83 kPa, the (average value±standard deviation) of the cell voltage is 0.496±0.0016 (V). When the value a is lower than 83 kPa, the (average value±standard deviation) of the cell voltage is 0.492±0.0025 (V). Accordingly, the value α is preferably not lower than 83 kPa. The thick frame in FIG. 7(A) indicates the range where the value α satisfies the condition of not lower than 83 kPa.

As shown in FIG. 15(B), the value α of not lower than 50 kPa gives the lower average value of the area resistance and the less variation of the area resistance, compared with the value α of lower than 50 kPa. When the value α is not lower than 50 kPa, the (average value±standard deviation) of the area resistance is 80.5±2.0 (mΩ·cm²). When the value α is lower than 50 kPa, the (average value±standard deviation) of the area resistance is 86.1±2.3 (mΩ·cm²). Accordingly, the value α is preferably not lower than 50 kPa. The thick frame in FIG. 7(B) indicates the range where the value α satisfies the condition of not lower than 50 kPa.

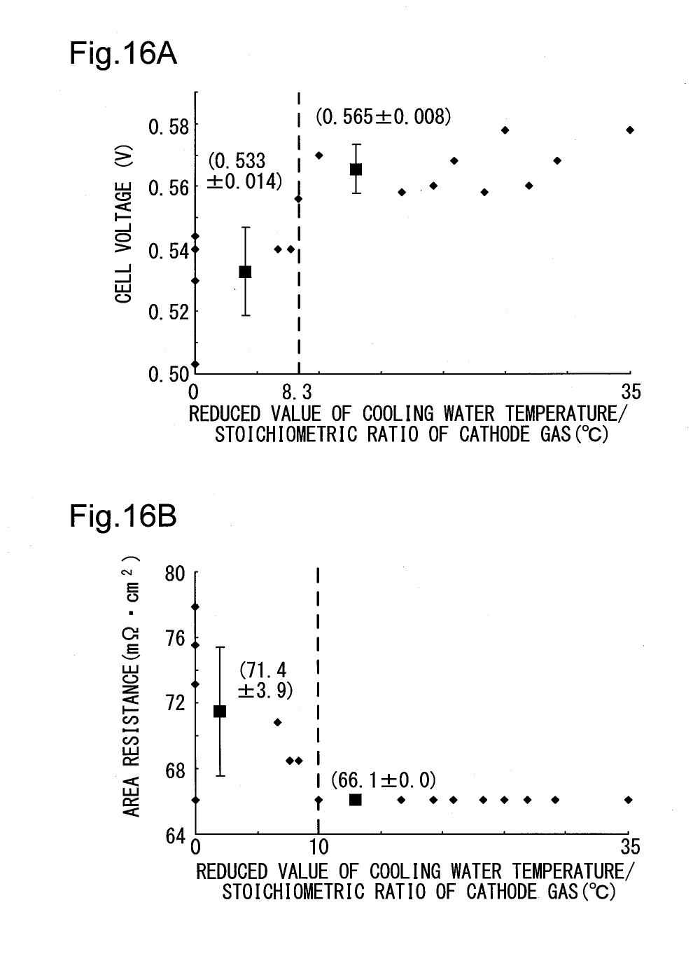

FIG. 16(A) is a graph with the cell voltage as ordinate and with the quotient (hereinafter referred to as “value β”) calculated by dividing a reduced value of the cooling water temperature by the stoichiometric ratio of the cathode gas as abscissa. The reduced value of the cooling water temperature denotes a difference between a changed target value for the cooling water temperature and a target value (65° C.) for the cooling water temperature under the ordinary condition. For example, when the changed target value for the cooling water temperature is 30° C., the reduced value is 35° C. FIG. 16(B) is a graph with the area resistance as ordinate and the value β as abscissa.

As shown in FIG. 16(A), the value β of not lower than 8.3° C. gives the higher average value of the cell voltage and the less variation of the cell voltage, compared with the value β of lower than 8.3° C. When the value β is not lower than 8.3° C., the (average value±standard deviation) of the cell voltage is 0.565±0.008 (V). When the value β is lower than 8.3° C., the (average value±standard deviation) of the cell voltage is 0.533 ±0.0014 (V). Accordingly, the value β is preferably not lower than 8.3° C. The thick frame in FIG. 8(A) indicates the range where the value β satisfies the condition of not lower than 8.3° C.

As shown in FIG. 16(B), the value β of not lower than 10° C. gives the higher average value β of the area resistance and the less variation of the area resistance, compared with the value β of lower than 10° C. When the value β is not lower than 10° C., the (average value±standard deviation) of the area resistance is 66.1±0.0 (mΩ·cm²). When the value β is lower than 10° C., the (average value±standard deviation) of the area resistance is 71.4±3.9 (mΩ·cm²). Accordingly, the value β is preferably not lower than 10° C. The thick frame in FIG. 8(B) indicates the range where the value β satisfies the condition of not lower than 10° C.

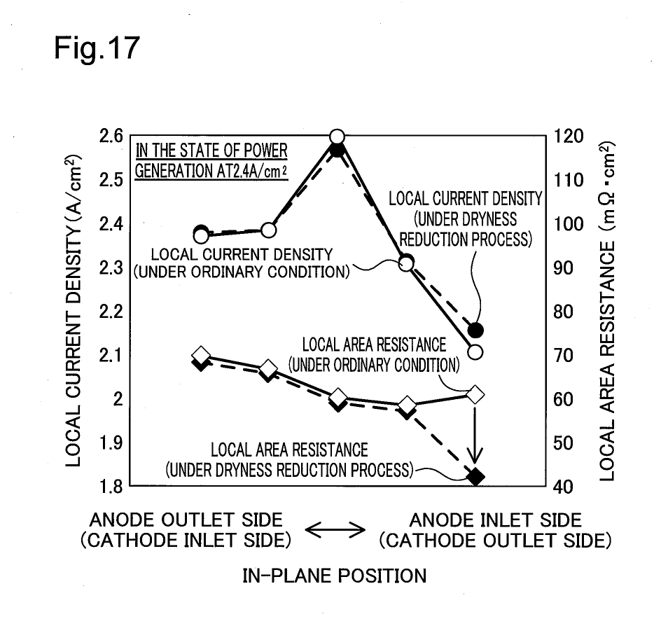

FIG. 17 is a graph showing relationships between the local current density and the in-plane position and relationships between the local area resistance and the in-plane position. This measurement was performed at the overall current density of the fuel cell stack 40 was 2.4 A/cm². The measurement was performed under two different conditions. The two different conditions herein are execution of the dryness reduction process and the ordinary condition. Execution of the dryness reduction process herein means execution of the cathode stoichiometric ratio control process and the cooling water temperature control process. The target value for the stoichiometric ratio of the cathode gas was set to 1.0, and the target value for the cooling water temperature was set to 30° C.

As shown in FIG. 17, the local current density under the dryness reduction process has a smaller difference between the maximum value and the minimum value, compared with the local current density under the ordinary condition. The smaller difference means that the local current density is leveled. As shown in FIG. 17, the local current density under the dryness reduction process has the decreased value at any in-plane position, compared with the local current density under the ordinary condition. The area resistance is significantly decreased especially in the periphery of the anode inlet. This decrease may be attributed to that the dryness reduction process suppresses the dryness in the periphery of the anode inlet.

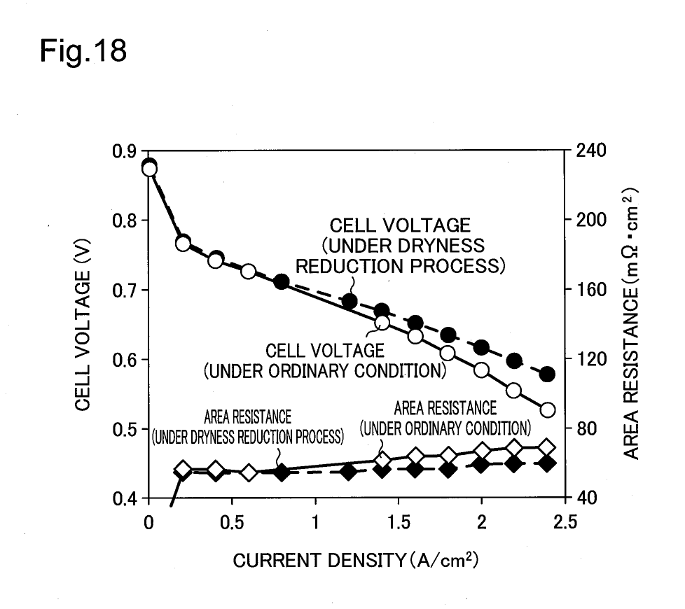

FIG. 18 is a graph showing relationships between the cell voltage and the current density and relationships between the area resistance and the current density. This measurement was also performed under the two conditions identical with those described in FIG. 17.

As shown in FIG. 18, when the current density is not higher than 0.8 A/cm², there are little differences between the values under the dryness reduction process and the values under the ordinary condition with regard to both the cell voltage and the area resistance. When the current density is not lower than 1.4 A/cm², on the other hand, execution of the dryness reduction process gives the more preferable values than the values under the ordinary condition, with an increase of the current density. This is because the higher current density is more likely to accelerate the dryness in the periphery of the anode inlet. Accordingly, it is preferable to perform the dryness reduction process in the state of the higher current density. It is especially preferable to perform the dryness reduction process when the current density is not lower than 1.4 A/cm².

The invention is not limited to any of the embodiments, the examples and the modifications described above but may be implemented by a diversity of other configurations without departing from the scope of the invention. For example, the technical features of the embodiments, examples or modifications corresponding to the technical features of the respective aspects described in Summary may be replaced or combined appropriately, in order to solve part or all of the problems described above or in order to achieve part or all of the advantageous effects described above. Any of the technical features may be omitted appropriately unless the technical feature is described as essential herein.

### REFERENCE SIGNS LIST

20 Fuel cell vehicle
30 Fuel cell system
40 Fuel cell stack
41 Unit cell
43 Membrane electrode assembly
45 Electrolyte membrane
47 Electrode applying region
50 Anode gas supply discharge mechanism
51 Hydrogen tank
52 Regulator
53 Anode gas circulation pump
54 Purge valve
55 Discharge pathway
56 Anode gas pressure gauge
57 Injector
60 Cathode gas supply discharge mechanism
61 Cathode gas supply path
62 Air compressor
63 Air flow meter
66 Cathode gas discharge path
67 Pressure regulating shutoff valve
68 Cathode gas pressure gauge
70 Cooling water circulation mechanism
71 Radiator
72 Cooling water circulation pump
73 Water temperature gauge
80 Power supply mechanism
90 Drive mechanism
91 Motor
92 Drive wheels
100 Control unit
110 Dryness reduction processor

1. A fuel cell system, in which a mass of a platinum catalyst per 1 cm² included in a cathode electrode is not higher than 0.2 mg, the fuel cell system comprising:
a fuel cell stack configured to receive supplies of anode gas and cathode gas such that direction of a flow of the anode gas supplied to an anode is opposed to direction of a flow of the cathode gas supplied to a cathode; and
a dryness reduction processor configured to perform at least one of controls of controlling temperature of the fuel cell stack to be not lower than 30° C. and not higher than 65° C., controlling a stoichiometric ratio of the cathode gas to be not lower than 1.0 and not higher than 1.5, controlling an outlet pressure of the anode gas to be not lower than 100 kPa and not higher than 250 kPa and controlling a stoichiometric ratio of the anode gas to be not lower than 1.25 and not higher than 5, in a case of power generation at a current density of not lower than 1.4 A/cm².

2. The fuel cell system according to claim 1,
wherein the dryness reduction processor controls the temperature of the fuel cell stack to be not lower than 30° C. and not higher than 65° C. and controls the stoichiometric ratio of the cathode gas to be not lower than 1.0 and not higher than 1.5.

3. The fuel cell system according to claim 2,
wherein the dryness reduction processor controls the temperature of the fuel cell stack to be not lower than 30° C. and not higher than 50° C.

4. The fuel cell system according to claim 3,
wherein the dryness reduction processor controls the temperature of the fuel cell stack to be not lower than 30° C. and not higher than 40° C.

5. The fuel cell system according to claim 2,
wherein the dryness reduction processor controls the stoichiometric ratio of the cathode gas to be not lower than 1.0 and not higher than 1.3.

6. The fuel cell system according to claim 5,
wherein the dryness reduction processor controls the stoichiometric ratio of the cathode gas to be not lower than 1.0 and not higher than 1.2.

7. The fuel cell system according to claim 2, further comprising:
a target temperature setter configured to set a target temperature of the fuel cell stack to a value under an ordinary operating condition after termination of the control of the temperature by the dryness reduction process, wherein
the dryness reduction processor controls the temperature of the fuel cell stack and the stoichiometric ratio of the cathode gas, such that a quotient increases to or above 8.3° C., wherein the quotient is calculated by dividing a difference, which is obtained by subtracting the target temperature set by the dryness reduction processor from the target temperature set by the target temperature setter, by the stoichiometric ratio of the cathode gas controlled to the target value.

8. The fuel cell system according to claim 7,
wherein the dryness reduction processor controls the temperature of the fuel cell stack and the stoichiometric ratio of the cathode gas, such that the quotient increases to or above 10° C.

9. The fuel cell system according to claim 2,
wherein the dryness reduction processor terminates the control of the temperature of the fuel cell stack when a cell voltage decreases to or below a reference value.

10. The fuel cell system according to claim 2,
wherein the dryness reduction processor terminates the control of the temperature of the fuel cell stack when the temperature of the fuel cell stack decreases to or below a target value.

11. The fuel cell system according to claim 2,
wherein the dryness reduction processor terminates the control of the stoichiometric ratio of the cathode gas when a cell voltage decreases to or below a reference value.

12. The fuel cell system according to claim 2,
wherein the dryness reduction processor terminates the control of the stoichiometric ratio of the cathode gas when the stoichiometric ratio of the cathode gas decreases to or below a target value.

13. The fuel cell system according to claim 1,
wherein the dryness reduction processor controls the outlet pressure of the anode gas to be not lower than 100 kPa and not higher than 250 kPa and controls the stoichiometric ratio of the anode gas to be not lower than 1.25 and not higher than 5.

14. The fuel cell system according to claim 13, wherein the dryness reduction processor controls the outlet pressure of the anode gas to be not lower than 150 kPa and not higher than 250 kPa.

15. The fuel cell system according to claim 14,
wherein the dryness reduction processor controls the outlet pressure of the anode gas to be not lower than 150 kPa and not higher than 200 kPa.

16. The fuel cell system according to claim 13,
wherein the dryness reduction processor controls the stoichiometric ratio of the anode gas to be not lower than 1.25 and not higher than 4.

17. The fuel cell system according to claim 16,
wherein the dryness reduction processor controls the stoichiometric ratio of the anode gas to be not lower than 1.25 and not higher than 3.

18. The fuel cell system according to claim 17,
wherein the dryness reduction processor controls the stoichiometric ratio of the anode gas to be not lower than 1.25 and not higher than 2.

19. The fuel cell system according to claim 18,
wherein the dryness reduction processor controls the stoichiometric ratio of the anode gas to be not lower than 1.25 and not higher than 1.66.

20. The fuel cell system according to claim 13,
wherein the dryness reduction processor controls the outlet pressure of the anode gas and the stoichiometric ratio of the anode gas, such that a quotient calculated by dividing the outlet pressure of the anode gas by the stoichiometric ratio of the anode gas increases to or above 50 kPa.

21. The fuel cell system according to claim 20,
wherein the dryness reduction processor controls the outlet pressure of the anode gas and the stoichiometric ratio of the anode gas, such that the quotient increases to or above 83 kPa.

22. An operating method of the fuel cell system according to claim 1.
